(19) United States
(12) Patent Application Publication
(10) Pub. No.: US 2020/0117179 A1
(43) Pub. Date: Apr. 16, 2020

(54) Method for Operating a Plant Apparatus and Plant Device

(71) Applicant: Siemens Aktiengesellschaft, Muenchen (DE)

(72) Inventor: Benjamin Lutz, Pfinztal (DE)

(73) Assignee: SIEMENS AKTIENGESELLSCHAFT

(21) Appl. No.: 16/599,771

(22) Filed: Oct. 11, 2019

(30) Foreign Application Priority Data
Oct. 14, 2018 (EP) 18200289

(51) Int. Cl. G05B 23/02; G05B 15/02

(52) U.S. Cl. CPC G05B 23/0272; G05B 15/02; G05B 23/027; G05B 23/0294

(57) ABSTRACT

A method for operating a plant apparatus having at least one first plant device and at least one second plant device separate from the first plant device, in which a first error message is generated by the first plant device and a second error message is generated by the second plant device, and the first error message and the second error message are transmitted to an electronic computing device of the plant apparatus for monitoring the plant apparatus, wherein at least one first procedural relevance is assigned to the first plant device and one second procedural relevance is assigned to the second plant device by the electronic computing device depending on a decision-making criterion and, depending on the respective assigned procedural relevance, a prioritization of the respective error messages is generated.

### BACKGROUND OF THE INVENTION

### 1. Field of the Invention

The invention relates to a plant apparatus having at least one first plant device, at least one second plant device and an electronic computing device and additionally relates to a method for operating the plant apparatus having the at least one first plant device and the at least one second plant device separate from the first plant device, in which a first error message is generated by the first plant device and a second error message is generated by the second plant device, and the first error message and the second error message are transmitted to an electronic computing device of the plant apparatus for monitoring the plant apparatus.

### 2. Description of the Related Art

A plant device in a plant apparatus may be responsible for several technological plant components. For example, an operator station can simultaneously provide the process images of a plurality of plant components or plant devices for servicing and observation or for automating the automation of a plurality of technical devices. In the event of a defect in a plant device, the procedural relevance can thus vary in significance. Depending on which procedural plant components are assigned thereto and the state, for example, a batch is running or a batch is not currently running, of the procedural plant component, the procedural relevance can be correspondingly significant.

In accordance with the prior art, although diagnostic information regarding corresponding plant devices is available in control systems of plant apparatus, these are usually offered by topographical trees and message lists without any procedural relevance and are also usually taken into account exclusively by maintenance personnel and not by operators. In particular, when multiple devices report errors or maintenance requirements, it is difficult to perform corresponding troubleshooting, the influence on the process sequence thus being the slightest. In the most unfavorable case, troubleshooting of the least procedural relevance is then started, for example.

### SUMMARY OF THE INVENTION

It is an object of the present invention to provide a method and a plant apparatus via which the plant apparatus can be operated more reliably.

This and other objects and advantages are achieved in accordance with the invention by a plant apparatus and a method for operating a plant apparatus with at least one first plant device and at least one second plant device separate from the first plant device, in which a first error message is generated by the first plant device and a second error message is generated by the second plant device, and the first error message and the second error message are transmitted to an electronic computing device of the plant apparatus for monitoring the plant apparatus.

In accordance with the invention, at least one first procedural relevance is assigned to the first plant device and one second procedural relevance is assigned to the second plant device by the electronic computing device depending on a decision-making criterion, and depending on the respective assigned procedural relevance, a prioritization of the respective error message is generated.

In other words, the procedural plant devices are brought into respective relationship with one another such that, depending on the respective generated error messages that can be prioritized and thereby improved, repair or maintenance of the respective plant devices can be performed, such that only a slight restriction of the plant apparatus is to be noted. Thus, an architecture and an implementation is created by which dynamically, particularly at the run-time of the plant device, the procedural relevance of the error messages can be determined and can be made graphically accessible for the purpose of coordinating correction and operation and observation. Operators, who can be considered as operators of the plant apparatus, of the plant, as well as maintenance personnel, can arrange the operation and observation as well as the maintenance of the current procedural plant devices more efficiently on this basis and thus prevent production losses or production restrictions.

Furthermore, this has the advantage that, during operation and observation by an operator of the plant apparatus, device-specific restrictions with an impact on the process technology can be seen immediately and troubleshooting can be performed thereafter accordingly. Furthermore, the method in accordance with the invention can also be provided so that maintenance personnel can better prioritize and better coordinate the elimination of device errors, in particular with respect to procedural side effects of a respective device error or of a respective error message.

In accordance with an advantageous embodiment, the plant apparatus is configured as a production plant for producing a product and a current generation step at which the product finds itself is determined as a decision-making criterion, where, as a function of the current generation step, a check is performed by the electronic computing device to determine whether the first plant device and/or the second plant device for producing the product is still required and depending thereupon, the respective procedural relevance is determined. In other words, the procedural relevance is decided by whether the first plant device and/or the second plant device are still required for the production of the product. If, to produce the product for example, first the first plant device is required and then the second plant device is required and it is determined that the product is already in the second plant device, where then, for example, the first error message is generated by the first plant device and the second error message is generated by the second plant device, it can thus be provided, for example, that the second procedural relevance for the second plant device is rated higher because the second plant device is still required for producing the product while the first plant device is no longer required. In accordance with the present production process and in particular as a function of the respective generation step of the current generation process, it thereby becomes possible to determine the procedural relevance, i.e., the procedural relevance of the respective plant device, and depending on the current generation step, the procedural relevance is then assigned to the respective plant device and prioritization is performed as a function thereof. This makes it possible for production losses and production restrictions to be kept as low as possible, allowing for improved operation of the plant apparatus.

It has also proven to be advantageous if the plant apparatus is configured as a production plant for producing a product and an evaluation of the respective plant device is performed as a decision-making criterion as a function of the frequency of use of the respective plant device during the production process of the product. If, for example, it is determined that the first plant device is required three times during the entire production process and the second plant device is only required once during the entire production process, then the first error message can be assigned a higher procedural relevance than the second error message. In particular, prioritization then occurs such that to repair the first plant device, this is assigned a higher priority than the second plant device. Thus, it can be decided, depending on the frequency of use of the respective plant device, which plant device should first be repaired or maintained in a corresponding error message. This makes it possible for production limitations to be reduced, as a result of which improved operation of the plant apparatus can be realized.

In another embodiment, the first error message and/or the second error message and/or the generated prioritization of the error messages are advantageously displayed on a display device of the electronic computing device. In particular, this makes it possible, for example, for the corresponding error message or the generated prioritization to be displayed on the display device to an operator of the plant device or an operator of the electronic computing device. In particular, it can then be provided that the operator can decide on the basis of the proposed prioritization by the electronic computing device which maintenance work or repairs should be performed as a priority. Thus, the plant devices that are to be maintained or repaired first can be easily displayed to an operator to be able to obviate a production loss or production restrictions accordingly. This results in improved operation of the plant device.

In a further embodiment, the first error message and/or the second error message and/or the prioritization of the error message are advantageously displayed on a display device of the electronic computing device during the operation of the plant device. In other words, the corresponding display occurs in real time, or online. This makes it possible, for example, for an operator who is sitting in front of the display device and observing the production process, to be informed in real time of the effects that the corresponding error messages of the plant devices have on the production process and in particular, to be able to intervene quickly and reliably in the repair and maintenance work in real time so that less time needs to be spent on repair. This allows for lower production losses or production restrictions of the plant apparatus. This results in improved operation of the plant apparatus.

In a further advantageous embodiment, a first pictogram for the first display device and a second pictogram for the second display device are additionally displayed on the display device, where the respective error message and prioritization are displayed as additional information for the first pictogram and/or the second pictogram. In other words, for example, it may be provided that a process display with the respective plant devices is displayed on the display device. If the first error message and/or the second error message then appears, this can be displayed as additional information relating to the respective pictogram of the plant devices. In particular, the respective prioritization can also be correspondingly displayed as additional information relating to the first pictogram and/or to the second pictogram. Should it be provided, for example, that the first plant device is assigned a higher priority than the second plant device, this can be indicated by the pictogram. For example, provision can be made for the prioritization to be displayed in accordance with the first plant device. For example, prioritization can be indicated by different colors on the display. For example, it can be provided that a red color is assigned to the more highly prioritized display device and a yellow color is assigned to the lower prioritized error message. Thus, the operator can quickly see which plant device has been assigned a higher prioritization or procedural relevance.

Furthermore, it can be provided, for example, that the prioritization or the procedural relevance can be indicated by letters or numbers. It can be provided, for example, that the respective plant device is assigned the higher procedural relevance with the number one as additional information, and the lower procedural relevance is indicated with the number two.

It is likewise possible for the corresponding procedural relevance to be correspondingly indicated as additional information with letters, for example, with A for high procedural relevance and B for low procedural relevance. This makes it possible for an operator of the electronic computing device or the display device to be shown simply and reliably which plant device has a correspondingly higher assigned procedural relevance, so that they can quickly and easily perform a repair or maintenance of the respective plant device. This results in lower production losses and production restrictions so that improved operation of the plant apparatus can be realized.

It is likewise advantageous if the first error message and/or the second error message on the display device are masked as a function of the prioritization. In other words, it can be provided, for example, that only the error message with the high procedural relevance is displayed accordingly, while the error message with the low procedural relevance is masked. In particular, it is thus possible for the corresponding prioritization to be displayed, for example, like an alarm, so that an operator in front of the display device can quickly and reliably perform the corresponding repair or maintenance work on the respectively displayed plant device. Thus, the corresponding procedural relevance can be displayed intuitively for the operator. This results in lower production losses and production restrictions so that the plant apparatus can be operated more reliably.

Furthermore, it has proven to be advantageous if the first error message and/or the second error message are evaluated via a respective diagnostic tree for each plant device. As a result, it can be realized, for example, that a detailed breakdown in the form of diagnostic trees can be displayed for each of the plant devices, which can be broken down to the field level. With these extended configurations, it is possible, in particular at runtime or online, to take account of error messages for each automation and for each operator station with respect to the procedural relevance. Improved operation of the plant apparatus is thus enabled.

It is likewise advantageous if, depending on the prioritization generated, a third plant device of the plant apparatus is started, where the first plant device and/or the second plant device is replaced by the third plant device during operation of the plant apparatus. In particular, the third plant device is thus provided as an alternative within the plant apparatus. For example, in a “batch” process, in other words, via a batch processing script, the third plant device can then be started accordingly, where no device alarm exists, in particular for the third plant device, so that the third plant device can replace the first plant device and/or the second plant device. This makes it possible for reduced losses to occur during the operation of the plant apparatus because the third plant device can replace the faulty first plant device and/or the faulty second plant device accordingly. In particular, depending on the prioritization, the third plant device will then replace the first plant device or the second plant device. In particular, the plant device with the more highly prioritized procedural relevance is correspondingly replaced by the third plant device. This makes it possible for production losses to be reduced, as a result of which improved operation of the plant apparatus can be realized.

It is also an object of the invention to provide a plant apparatus having at least one first plant device, having at least one second plant device and an electronic computing device, where the plant apparatus is configured to implement the method in accordance with the disclosed embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages will be apparent from the following description with reference to the accompanying figures where, the same reference characters designate the same features and functions, and where the exemplary embodiments are merely illustrative of the invention and are not intended to limit this, and where the invention is now explained in more detail with reference to the accompanying diagrams, in which:

FIG. 1 shows a schematic view of an embodiment of a display device of an embodiment of a plant apparatus in accordance with the invention;

FIG. 2 shows a further schematic view of an embodiment of a display device of an embodiment of the plant apparatus in accordance with the invention;

FIG. 3 shows a schematic block diagram of an embodiment of the plant apparatus in accordance with the invention; and

FIG. 4 is a flowchart of the method in accordance with the invention.

### DETAILED DESCRIPTION OF THE PRESENTLY EXEMPLARY EMBODIMENTS

The exemplary embodiments illustrated in more detail hereinafter represent preferred embodiments of the present invention.

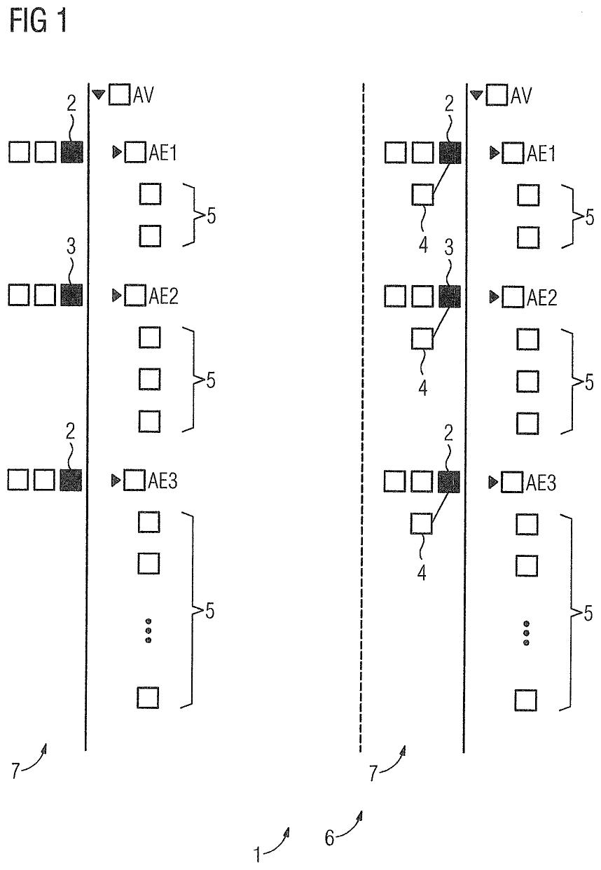

FIG. 1 shows in a schematic view an embodiment of a display device 1 of an embodiment of a plant apparatus AV. In the present exemplary embodiment, the plant apparatus AV has a first plant device AE1, a second plant device AE2 and a third plant device AE3. In the present exemplary embodiment, two possibilities for optical display are shown in each case. On the left side of FIG. 1, it is shown that a respective plant device AE1, AE2, AE3 can show respective error messages 2, 3. A first error message 2 can be generated by the first plant device AE1, a second error message 3 can be generated by the second plant device AE2 and in the present exemplary embodiment a third error message can be generated by the third plant device AE3, which corresponds to the first error message in the exemplary embodiment. In other words, the first error message 2 has an influence on the first plant device AE1 and on the third plant device AE3.

In other words, the procedural plant devices AE1, AE2, AE3 are brought into respective relation to one another so that, depending on the respective generated error messages 2, 3, these can be prioritized and repair or maintenance of the respective plant devices AE1, AE2, AE3 can be performed in an improved manner, so that only a slight restriction of the plant apparatus AV is to be noted. Thus, an architecture and an implementation is generated, based on which dynamically, in particular at runtime of the plant apparatus AV, the procedural relevance of the error messages 2, 3 can be determined and made graphically accessible for the purpose of coordination of remedy and operation and observation. Operators, who can be considered as operators of the plant apparatus AV, of the plant, as well as maintenance personnel, can arrange the operation and observation as well as the maintenance of the current procedural plant devices AE1, AE2, AE3 more efficiently on this basis and thus prevent production losses or production restrictions.

Furthermore, this has the advantage that, during operation and observation of the plant apparatus AV by an operator, device-specific restrictions with an impact on the process technology can be seen immediately and troubleshooting can be performed thereafter accordingly. Furthermore, the method in accordance with the invention can also be provided so that maintenance personnel can better prioritize 7 and better coordinate the elimination of device errors, in particular with respect to procedural side effects of a respective device error or of a respective error message 2, 3.

The respective plant devices AE1, AE2, AE3 can be evaluated with the aid of a respective diagnostic tree 5 of the respective plant devices AE1, AE2, AE3.

It is provided that for operating the plant apparatus AV with at least the first plant device AE1 and the at least second plant device AE2 separate from the first plant device AE1, the first error message 2 is generated by the first plant device AE1 and the second error message 3 is generated by the second plant device AE2 and the first error message 2 and the second error message 3 are transmitted to an electronic computing device 6 of the plant apparatus AV for monitoring the plant apparatus AV.

It is provided that, depending on a decision-making criterion, at least one first procedural relevance is assigned to the first plant device AE1 and one second procedural relevance to the second plant device AE2 by the electronic computing device 6 and depending on the respectively assigned procedural relevance, a prioritization 7 of the respective error messages 2, 3 is produced.

FIG. 1 shows the expansion of an equipment hierarchy online configuration here by way of example, as it is applied, for example, generated by the engineering or the organization in a production process of a product, in particular at runtime. In this case, which procedural plant devices AE1, AE2, AE3, represented in particular in the equipment hierarchy online by structure folders, are automated and observed by which devices is recorded here.

FIG. 1 now shows that the error messages 2, 3 to determine the procedural relevance can be displayed accordingly. Overlaying can occur, for example, by an operator by folding out, as shown on the right side of FIG. 1, or by folding in, as can be seen on the left side of FIG. 1.

In FIG. 1, it can be seen on the right side that further information 4, is assigned to the respective error message 2, 3. In particular, it can be seen that a first pictogram and a second pictogram for the second plant device AE2 are displayed on the display device 1, where the respective error message 2, 3 and prioritization 7 are displayed as additional information 4 of the first pictogram and/or the second pictogram.

Furthermore, FIG. 1 shows that, depending on prioritization 7, the first error message 2 and/or the second error message 3 can be masked on the display device 1.

Furthermore, FIG. 1 shows that, depending on the generated prioritization 7 in the third plant device AE3, the plant apparatus AV can be started, where the first plant device AE1 and/or the second plant device AE2 is replaced by the third plant device AE3 during operation of the plant apparatus AV. In particular, the third plant device AE3 is thus provided as an alternative within the plant apparatus AV. For example, in a “batch” process, in other words, via a batch processing script, the third plant device AE3 can then be started accordingly, where no device alarm exists, in particular for the third plant device AE3, so that the third plant device AE3 can replace the first plant device AE1 and/or the second plant device AE2. This makes it possible for reduced losses to occur during the operation of the plant apparatus AV because the third plant device AE3 can replace the faulty first plant device AE1 and/or the faulty second plant device AE2 accordingly. In particular, depending on the prioritization 7, the third plant device AE3 will then replace the first plant device AE1 or the second plant device AE2. In particular, the plant device AV with the more highly prioritized procedural relevance is correspondingly replaced by the third plant device AE3. This makes it possible for production losses to be reduced, as a result of which improved operation of the plant device can be realized.

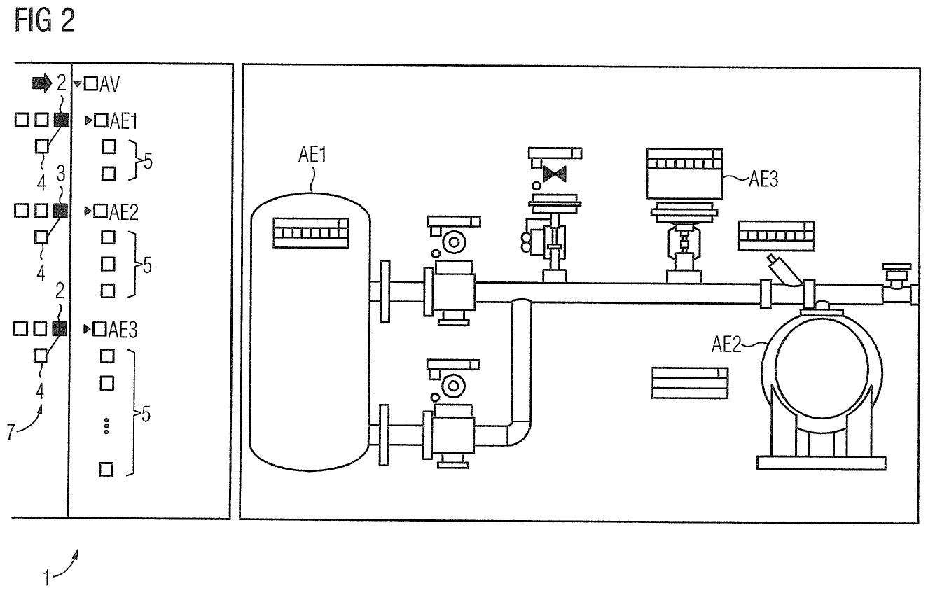

FIG. 2 shows a schematic view of a further embodiment of a display device 1 of an embodiment of the plant apparatus AV. In the present exemplary embodiment, in particular, the integration of the equipment hierarchy is displayed online in a view. In particular, the equipment hierarchy is represented online with the inserted and combined error messages 2, 3, which are now possible through the method in accordance with the invention with the respective representation of an alarm source in the form of the plant device AE1, AE2, AE3. It can be seen that several error messages 2, 3 relevant to the process are present at the same time, where the first error message 2 is more significant in the present case because it has an effect on two procedural plant devices AE1, AE2, AE3. This error should accordingly be addressed first. Furthermore, the operator could, for example, start the alternative of the third plant device AE3, for example, a batch process on a procedural plant component, if the error message 2, 3 is present.

Furthermore, FIG. 2 shows how, for example, the display device 1 is accessible to the operator. The operator can now check online immediately during operation and during observation in the course of navigation with the equipment hierarchy, whether during operation and observation of the respective plant devices AE1, AE2, AE3 an error message 2, 3 is present that must be taken into account accordingly and how prioritization 7 should look in troubleshooting of the respective error messages 2, 3, based on the respective procedural relevance.

FIG. 2 additionally shows that the plant apparatus AV is configured as a production plant for producing a product and a current generation step at which the product finds itself is determined as a decision-making criterion, where depending on the current generation step, the electronic computing device 6 performs a check to determine whether the first plant device AE1 and/or the second plant device AE2 is still required to produce the product and depending thereon, the respective procedural relevance is determined. In other words, the procedural relevance is decided by whether the first plant device AE1 and/or the second plant device AE2 are still required for production of the product. If, to produce the product for example, initially the first plant device AE1 is required and then the second plant device AE2 is required and it is determined that the product is already in the second plant device AE2, where then, for example, the first error message 2 is generated by the first plant device AE1 and the second error message 3 is generated by the second plant device AE2, it can thus be provided, for example, that the second procedural relevance for the second plant device AE2 is rated higher as the second plant device AE2 is still required for producing the product while the first plant device AE1 is no longer required. In accordance with the present production process and in particular as a function of the respective generation step of the current production process, it is thereby possible to determine the procedural relevance, i.e., the procedural relevance of the respective plant device AE1, AE2, AE3 and depending on the current generation step, the procedural relevance is then assigned to the respective plant device AE1, AE2, AE3 and prioritization 7 is performed as a function thereof. This makes it possible for production losses and production restrictions to be kept as low as possible, allowing for improved operation of the plant apparatus AV.

Furthermore, FIG. 2 shows that the plant apparatus AV is configured as a production plant for producing a product and an evaluation of the respective plant device AE1, AE2, AE3 is performed as a decision-making criterion as a function of the frequency of use of the respective plant device AE1, AE2, AE3 during the production process of the product.

FIG. 2 further shows that the first error message 2 and/or the second error message 3 and/or the generated prioritization 7 of the error messages 2, 3 are displayed on the display device 1 of the electronic computing device 6. In particular, it can be seen that the first error message 2 and/or the second error message 3 and/or the prioritization 7 of the error messages 2, 3 are displayed on a display device 1 of the electronic computing device 6 during the operation of the plant apparatus AV.

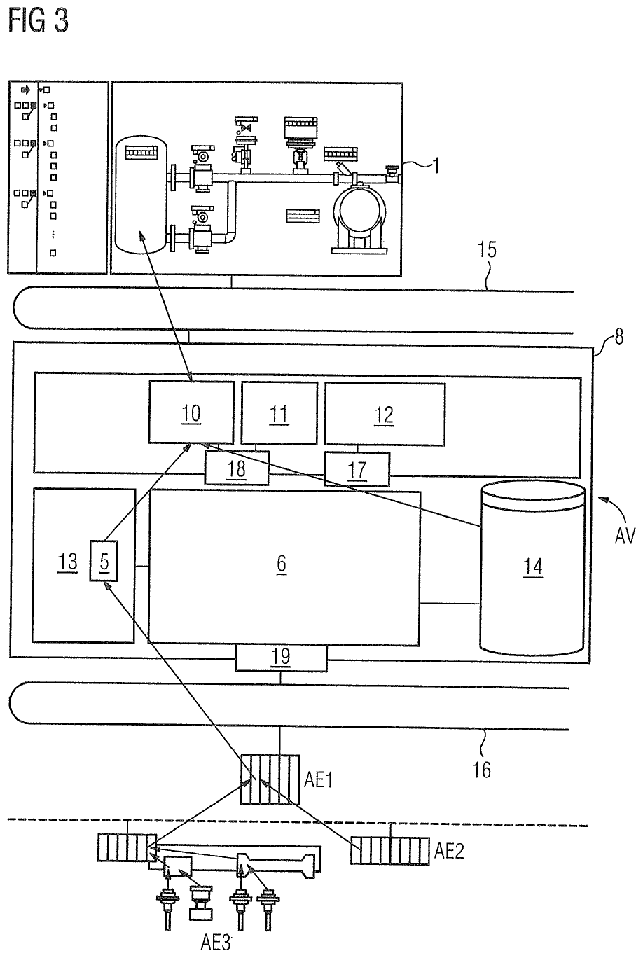

FIG. 3 shows a schematic block diagram of an embodiment of a plant apparatus AV for integrating the equipment hierarchy online in an Operation Station Server 8 that can also be referred to as an operator server, and the display device 1. The Operation Station Server 8 has a visualization device 9 for this purpose. The visualization device 9 in turn comprises the equipment hierarchy 10, a display hierarchy 11 and a process object 12. The equipment hierarchy 10 in turn is coupled to a diagnostic manager 13 of the Operation Station Server 8 and to the display device 1. Furthermore, the equipment hierarchy 10 has access to corresponding resources 14. The Operation Station Server 8 in turn is coupled to a bus system 15 with the display device 1. Furthermore, for controlling the respective plant devices AE1, AE2, AE3, the operation station server 8 is coupled to a further bus system 16. Furthermore, in particular the diagnostic manager 13 is equipped with the diagnostic trees 5. In particular, it can also be provided that the Operation Station Server 8 can have the electronic computing device 6, via which, for example, corresponding displays or events can be managed.

Furthermore, the visualization device 9 has an alarm DS 17 and a tag DS 18. The Operation Station Server 8 in turn has in particular an AS driver 19.

FIG. 3 shows in particular the architecture and integration of the equipment hierarchy 10 in the Operation Station Server 8 and the display device 1 to enable the determination of the procedural relevance of device diagnostic data at runtime for efficient coordination of maintenance procedures. As already explained, the equipment hierarchy online configuration, which is extended automatically in engineering and device assignment, is correspondingly loaded on the operation station server 8, which in turn can be consumed and correspondingly visualized by the software component, in particular by the equipment hierarchy 10. In addition, the equipment hierarchy 10 obtains the assigned plant devices AE1, AE2, AE3 and the respective device diagnostic data from the diagnostic tree 5 from the diagnostic manager 13 so that they can be visualized accordingly on the display device 1.

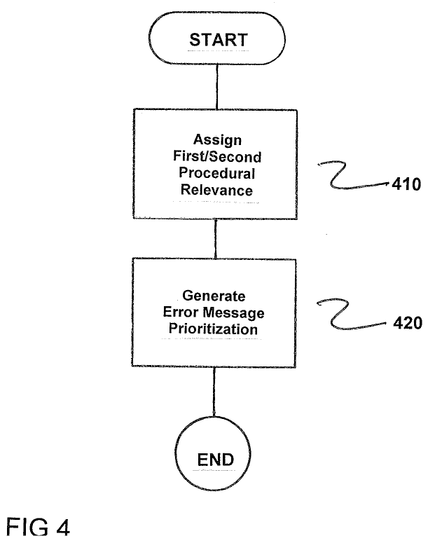

FIG. 4 is a flowchart of the method for operating a plant apparatus AV having at least one first plant device AE1 and at least one second plant device AE2 separate from the first plant device AE1, in which a first error message 2 is generated by the first plant device AE1 and a second error message 3 is generated by the second plant device AE2, and the first error message 2 and the second error message 3 are transmitted to an electronic computing device 6 of the plant apparatus AV for monitoring the plant apparatus AV.

The method comprises assigning at least one first procedural relevance to the first plant device AE1 and assigning one second procedural relevance to the second plant device AE2 by the electronic computing device 6 depending on a decision-making criterion, as indicated in step 410.

Next, a prioritization 7 of the respective error message 2, 3 is generated depending on a respective assigned procedural relevance, as indicated in step 420.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a plant apparatus having at least one first plant device and at least one second plant device separate from the first plant device, in which a first error message is generated by the first plant device and a second error message is generated by the second plant device, and the first error message and the second error message are transmitted to an electronic computing device of the plant apparatus for monitoring the plant apparatus, the method comprising:
assigning at least one first procedural relevance to the first plant device and assigning one second procedural relevance to the second plant device by the electronic computing device depending on a decision-making criterion; and
generating a prioritization of the respective error message depending on a respective assigned procedural relevance.

2. The method as claimed in claim 1, wherein the plant apparatus comprises a production plant for producing a product and a current generation step at which the product situated is determined as a decision-making criterion; and
wherein depending on the current generation step, the electronic computing device performs a check to determine whether at least one of the first plant device and the second plant device is still required to produce the product, and depending on a result of said determination, a respective procedural relevance is determined.

3. The method as claimed in claim 1, wherein the plant apparatus comprises a production plant for producing a product and an evaluation of a respective plant device is performed as the decision-making criterion as a function of a frequency of use of a respective plant device during the production process of the product.

4. The method as claimed in claim 1, wherein at least one of the first error message, the second error message and the generated prioritization of the first and second error messages are displayed on a display device of the electronic computing device.

5. The method as claimed in claim 1, wherein at least one of the first error message, the second error message and the generated prioritization of the first and second error messages are displayed on a display device of the electronic computing device during operation of the plant apparatus.

6. The method as claimed in claim 4, wherein a first pictogram for the first plant device and a second pictogram for the second plant device are additionally displayed on the display device; and
wherein the respective error message and the generated prioritization are displayed as additional information of at least one of the first pictogram and the second pictogram.

7. The method as claimed in claim 5, wherein a first pictogram for the first plant device and a second pictogram for the second plant device are additionally displayed on the display device; and
wherein the respective error message and the generated prioritization are displayed as additional information of at least one of the first pictogram and the second pictogram.

8. The method as claimed in claim 4, wherein at least one of the first error message and the second error message are one of masked and inserted on the display device depending on the generated prioritization.

9. The method as claimed in claim 5, wherein at least one of the first error message and the second error message are one of masked and inserted on the display device depending on the generated prioritization.

10. The method as claimed in claim 6, wherein at least one of the first error message and the second error message are one of masked and inserted on the display device depending on the generated prioritization.

11. The method as claimed in claim 1, wherein at least one of the first error message and the second error message are evaluated via a respective diagnostic tree for each of plant device.

12. The method as claimed in claim 1, further comprising:
starting a third plant device of the plant apparatus a function of the generated prioritization;
wherein at least one of the first plant device and the second plant device is replaced by the third plant device during operation of the plant apparatus.

13. A plant apparatus comprising:
at least one first plant device;
at least one second plant device; and
an electronic computing device;
wherein the plant apparatus is configured to:
assign at least one first procedural relevance to the first plant device and assign one second procedural relevance to the second plant device by the electronic computing device depending on a decision-making criterion; and
generate a prioritization of the respective error message depending on a respective assigned procedural relevance.
